(19) United States
(12) Patent Application Publication
(10) Pub. No.: US 2002/0171857 A1
(43) Pub. Date: Nov. 21, 2002

(54) Information printing system

(75) Inventors: Kenji Hisatomi, Osaka (JP); Kazuyuki Murata, Kyotanabe-shi (JP)

Correspondence Address: GREENBLUM & BERNSTEIN, P.L.C., 1941 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/146,446

(22) Filed: May 16, 2002

(30) Foreign Application Priority Data
May 17, 2001 (JP) JP2001-148380
Jul. 16, 2001 (JP) JP2001-216027

(51) Int. Cl. G06F 15/00; B41F 1/00

(52) U.S. Cl. 358/1.13

(57) ABSTRACT

An information printing system that is capable of printing data, which is handled by an arbitrary client apparatus of a digital system, in an output format suitable for printing, with a relatively simple structure without using a printer driver. In this system, conversion rule information, which is used to convert BML data (digital broadcast contents) into XML data (XML data for printing) printable by the corresponding printer 200, is pre-stored in the printer 200. A receiver 100 downloads necessary conversion rule information from the printer 200 with given timing, and converts received BML data to XML data for printing based on the conversion rule information, and transmits a conversion result (XML data for printing) to the printer 200.

### BACKGROUND OF THE INVENTION

1. Field of the Invention

The present invention relates to an information printing system.

2. Description of Related Art

Conventionally, a computer such as a personal computer has mainly been used as a source of transmission data to be printed by a printer, that is, a data source for a printer.

Generally, in personal computers, since the specification of a printer is different from one model to another (and from one manufacturer to another) and then management of all printers by an OS (operating system) itself is inefficient, it is so designed that a program for controlling the printer is separated from the OS itself and that a program suitable for a printer to be used (generally called printer driver) is installed as required. Accordingly, if the printer driver is developed for each model of the printer (in addition, each OS of the personal computer), any personal computers, with a driver suitable for a printer to be used installed, can perform printing using the printer.

However, with recent developments in information-related technology (IT), the variety of data sources of printers have been widened, and the following data as well as the print data from personal computers, for example, can be considered to be printed by the printers:

1) Multimedia data and print data received by a digital broadcast receiver;

2) Web page data and downloaded print data, which is acquired by making connection to the Internet via a cellular phone/fixed phone/personal digital assistant (hereinafter referred to as “cellular phone etc.”);

3) Web page data displayed on the Internet terminals other than on personal computers and downloaded print data.

In this case, a client apparatus (data source) conforming to digital format, which issues a request for printing, such as a digital broadcast receiver, cellular phone, the Internet terminal, etc., is connected to the printer via a cable, wireless or network, and carries out transmission of print data to the printer and setting of printing conditions. Additionally, the client apparatus excluding the personal computer is hereinafter referred to as client apparatus in narrower sense.

However, unlike the personal computers, various client apparatuses (in narrower sense) exist which vary from each other in terms of performance/type of OS and CPU, capacity/presence or absence of a memory and storage device. Therefore, the printing method under the application using the printer driver cannot be applied uniformly, unlike the personal computers. Accordingly, a new approach for performing printing from the client apparatus (in narrower sense) must be devised. This approach is, of course, also applicable to the personal computers.

For example, in the case of digital broadcast receiver, the OS installed inside and the CPU in use vary from one manufacturer to another. This means that the same method in which the printer driver is installed on PCs cannot be used.

On the other hand, the multimedia contents to be digitally broadcasted are produced for the purpose of display and reproduction on a digital broadcast receiving system, and are described in the specific markup language, which is called BML (Broadcast Markup Language). Notwithstanding its broadcast nature, there is a need to print out the contents (BML contents) described in BML language for the purpose of display and reproduction.

In this case, it is indeed possible to print out the digital broadcast contents (BML contents) using a video printer, which has a function of producing hard copies of a TV screen of the digital broadcast receiving system. Under this method, however, the quality of contents decompressed with lower resolution, especially characters, deteriorates when printed out. Moreover, as another drawback, even objects for which there is no need to print out, for example, an object displayed for only remote control, are printed each time the hard copy of screen is carried out.

### SUMMARY OF THE INVENTION

It is an object of the present invention to provide an information printing system that is capable of printing data (information), which is handled by an arbitrary client apparatus of a digital system, in an output form suitable for printing, with a relatively simple structure without using a printer driver.

According to an aspect of the invention, an information printing system comprises a client apparatus that processes document data in a first markup language format described in a first markup language and a printing apparatus that is connected to the client apparatus and that receives and prints document data in a second markup language format described in a second markup language different from the first markup language. The printing apparatus comprises means for storing conversion rule information that is used to convert document data in the first markup language format processable by the client apparatus into document data in the second markup language format printable by the printing apparatus, and means for obtaining the conversion rule information from the storing means and transmitting the obtained conversion rule information to the client apparatus. The client apparatus comprises means for receiving the conversion rule information transmitted from the printing apparatus, means for converting the document data in the first markup language format into the document data in the second markup language format, based on the received conversion rule information, and means for transmitting the document data in the second markup language format after conversion to the printing apparatus.

According to another aspect of the invention, an information printing system comprises a client apparatus and a printing apparatus connected to the client apparatus. The printing apparatus comprises means for storing printing condition setting processing information that is described in a markup language processable by the client apparatus and that includes a script for setting a printing condition to the printing apparatus by the client apparatus, and means for obtaining the printing condition setting processing information from the storing means and transmitting the obtained printing condition setting processing information to the client apparatus. The client apparatus comprises means for receiving the printing condition setting processing information transmitted from the printing apparatus, means for controlling a user interface based on the received printing condition setting processing information to set a printing condition in accordance with an input from a user, and means for transmitting the set printing condition to the printing apparatus.

The above and other objects and features of the present invention will become clear from the following description of the preferred embodiments taken in conjunction with the accompanying drawings.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a block diagram showing the configuration of an information printing system according to Embodiment 1 of the present invention;

FIG. 2 is a flowchart showing the operation of a receiver corresponding to Embodiment 1;

FIG. 3 is a flowchart showing the operation of a printer corresponding to Embodiment 1;

FIG. 4 is an operation sequence diagram showing processing procedures to be executed when digital broadcast contents received by a receiver are output by the printer;

FIG. 5 is a diagram specifically showing one example of language conversion;

FIG. 6 is a block diagram showing the configuration of an information printing system according to Embodiment 3 of the present invention;

FIG. 7 is one example of a part of the description of printing condition setting processing information for BML;

FIG. 8 is one example of a screen in which printing condition setting processing information is displayed by a BML browser;

FIG. 9 is a flowchart showing the operation of a receiver corresponding to Embodiment 3;

FIG. 10 is a flowchart showing the operation of a printer corresponding to Embodiment 3;

FIG. 11 is an operation sequence diagram showing processing procedures to be executed when the receiver sets printing conditions for printing by the printer digital broadcast contents received in the receiver;

FIG. 12 is a block diagram showing the configuration of an information printing system according to Embodiment 4 of the present invention;

FIG. 13 is an operation sequence diagram showing procedures to be executed when Web contents received by the Internet terminal are printed by the printer (including procedures to be executed when the Internet terminal sets the printing conditions);

FIG. 14 is a block diagram showing the configuration of an information printing system according to Embodiment 5 of the present invention; and

FIG. 15 is an operation sequence diagram showing procedures to be executed when i-mode contents received by a cellular phone are printed by the printer (including procedures to be executed when the cellular phone sets the printing conditions.

### DESCRIPTION OF THE PREFERRED EMBODIMENTS

The outline of the present invention is that predetermined conversion rule information/printing condition setting processing information is pre-stored in a printer, the conversion rule information/printing condition setting processing information is transferred to a client apparatus from the printer with given timing, and the client apparatus performs language conversion to get data in a format printable by the printer/printing condition setting processing for print data, and transmits the results to the printer.

The following will specifically explain the preferred embodiments of the present invention with reference to the drawings accompanying herewith.

(Embodiment 1)

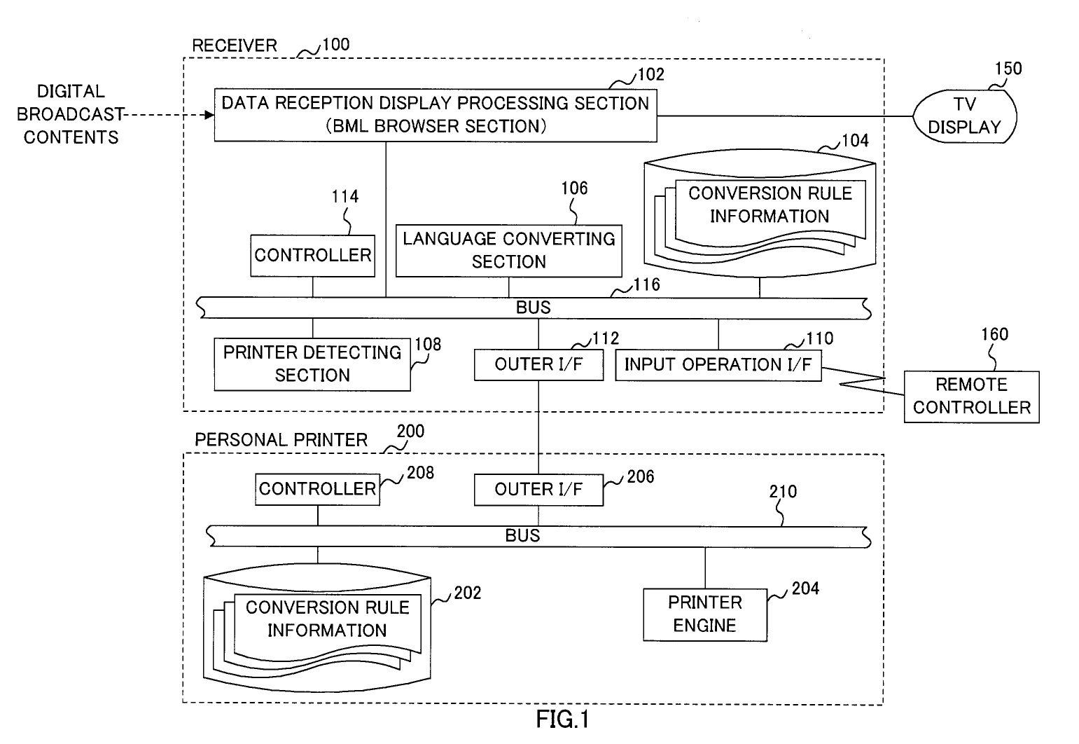

FIG. 1 is a block diagram showing the configuration of an information printing system according to Embodiment 1 of the present invention.

This information printing system is a system that prints out received digital broadcast contents. The information printing system comprises a receiver 100 (client apparatus) which receives the digital broadcast contents, and a personal printer 200 (hereinafter simply referred to as “printer”) (printing apparatus) which is connected to thereceiver100 and which receives and prints data for printing from the receiver 100. A television (TV) display 150, which displays the digital broadcast contents received by the receiver 100, is connected to the receiver 100. The receiver 100, printer 200, and TV display 150 are set up in general homes. Namely, in the example of FIG. 1, the receiver 100 takes the form that is called a set top box (STB). A receiving system is composed of the receiver 100 having a function of receiving, selecting and decoding a broadcast wave, and the television (TV display 150) that performs display output. The user's input command to the receiving system is carried out with an attached remote controller 160. In addition, the receiving system is not limited to the configuration in which the receiver (STB) and the television are separated. Another configuration where the receiver is built in the television as in a digital television (DVD) configuration is also possible.

Here, the digital broadcast contents are composed of various kinds of monomedia such as characters, moving images, still images, sound, etc., and they are described by a markup language, which is called BML (Broadcast Markup Language) as mentioned above. BML refers to a markup language for describing digital broadcast contents (XML: Extensible Markup Language) that can be expressed by combinations of a plurality of monomedia and that can define the remote control manipulation. In other words, BML is one application language of XML, and is defined optimally to reproduce (display) multimedia data on the digital broadcast receiving system. The definition of XML for each application is given with DTD (Document Type Definition), which defines a document type. Hereafter, document data described in BML format and document data described in XML format are simply referred to as “BML data” and “XML data”, respectively. Each document data may contain images and sound.

Regarding the optimal definition of XML, which is most suitable for printing at the printer, there is no standard at the present. The reproduction capability of printer varies from one printer to another, depending on various factors such as, whether it is a color-type printer or monochrome-type printer, which font types are available for printing, which paper sizes are used, and so on. For this reason, it is desirable that the optimal XML should be used for each model of printer.

However, as mentioned above, since the OS installed and the CPU inside vary from one manufacturer to another, the digital broadcast receiver cannot adopt the same method for printing in which a printer driver is installed, unlike the personal computer.

Therefore, taking a different approach, according to the configuration of this embodiment, conversion rule information used for converting BML data into XML data such as Xhtml-Print etc. (hereinafter referred to as “XML data for printing”), which is printable by the corresponding printer 200, is pre-stored in the printer 200, and then the conversion rule information is transferred from the printer 200 to the receiver 100 with predetermined timing, and the receiver 100 converts the received BML data into XML data for printing based on transferred conversion rule information, and transmits a conversion result (XML data for printing) to the printer 200. The XML data for printing is one of XML applications, and DTD of XML for printing is arbitrarily definable according to the model of printer 200. The predetermined rule for performing format conversion from BML data that complies with DTD of BML into XML data for printing that complies with DTD of XML for printing is conversion rule, and arbitrary conversion rule information can be defined according to the model of printer. When receiving XML data for printing from the receiver 100, the printer 200 interprets XML data for printing, converts character codes and image objects into print bitmap data, and then executes printing.

As shown in FIG. 1, the receiver 100 comprises a data reception display processing section 102, a conversion rule information storing section 104, a language converting section 106, a printer detecting section 108, an input operation interface (I/F) 110, an outer interface 112, a controller 114, and a bus 116. The controller 114 is connected to the respective components 102 to 112 through the bus 116, and performs centralized control of the respective components 102 to 112.

The functional details of the above elements are given below.

The data reception display processing section 102 performs processing for receiving digital broadcast contents (BML data), storing them and displaying them on the TV display 150. This processing is executed by a processing program, which is called the BML browser. The BML browser is generally mounted on the receiver 100.

The conversion rule information storing section 104 temporarily stores the conversion rule information transferred from the printer 200. The conversion rule information is one that is used to convert BML data into printing XML data, which is printable by the printer 200, as mentioned above. More specifically, this is provided in the form of a style sheet that contains the description format of XML data. Data is described on the style sheet using the language for a style sheet in a predetermined format.

The language converting section 106 converts BML data into XML data for printing based on the conversion rule information temporarily stored in the conversion rule information storing section 104. This conversion processing is executed by a conversion program, which is called as XSLT (extensible style sheet language transform) processor. The XSLT processor is a program that transforms the description of a certain XML application into the description of another XML application, and this is normally mounted on the receiver 100. In such case, conversion rule information used by the XSLT processor is provided in the form of a style sheet described in the language in XSLT format (hereinafter referred to as “XSLT style sheet”). The aforementioned XSLT style sheet, which is used to perform conversion from BML into printable XML for printing by the XSLT processor, is pre-stored in the printer 200 connected to the receiver 100. The details of processing by an XSLT processor and the description method of XSLT style sheet are specifically described in “XSLT” of W3C (World Wide Web Consortium) recommendation.

Because BML data of digital broadcast contents is multimedia contents as explained above, moving pictures encoded by MPEG2 or other video compression format, audio, music, objects such as an animation, could be contained therein in some cases. In such case, audio and music data, or a script that defines the interactive operations, all of which are unnecessary for printing, are deleted by the XSLT processor during language conversion process. To print out the moving pictures, it is necessary at the receiver 100 side to convert motion picture data into still picture data to replace a moving picture object of BML with a still picture object for printing. In the case of the moving picture encoded by MPEG2, one frame (an inner-frame encoded frame) is extracted from a stream of the moving picture frames and the extracted frame is converted into JPEG data, whereby conversion is carried out easily.

Moreover, the style sheet for screen display that comprises BML (see “CSS (Cascading Style Sheet)” of W3C recommendation) is converted into one that is suitable for printing and that matches the capability of printer 200 by processing carried out by the XSLT processor during language conversion processing.

The printer detecting section 108 detects the presence of the printer 200. More specifically, for example, the printer detecting section 108 detects the connection of the printer 200 to the receiver 100 and also detects the condition that the power of the printer 200 connected to the receiver 100 is turned on, and outputs a detection signal indicative of such detection. When the detection signal is issued from the printer detecting section 108, the receiver 100 requests the printer 200 to transfer XSLT style sheet (conversion rule information) for conversion of BML data into XML data for printing.

The input operation interface 110 is a module that processes the input commands from the user. For example, the input operation interface 110 includes an operation button/switch (not shown), which is used when the user carries out a direct manual operation, and also has a function of receiving remote control commands from the remote controller 160 through infrared rays, etc. The input operation interface 110 could contain a display panel for displaying the current setting or LED indicators (both not shown).

The outer interface 112 is a module that connects the receiver 100 and printer 200 to each other to allow mutual communication therebetween to be carried out. The connection between the receiver apparatus 100 and the printer 200 is made using any arbitrary connection method, for example, a cable system such as USB, IEEE 1394, etc., wireless system such as Bluetooth, IEEE 802.11 standard, a peer to peer system, or a network connection system, etc.

The controller 114 has a function of controlling the operation of the entire receiver 100 where the respective components 102 to 112 are given centralized control. The controller 114 includes CPU, which performs various kinds of computation and control, ROM, which stores a program and data, and RAM, which stores data temporarily (any not shown). The ROM may be flash memory that is capable of electrically rewriting the contents.

While, the printer 200 connected to the receiver 100 includes a conversion rule information storing section 202, a printer engine 204, an outer interface 206, a controller 208, and a bus 210 as illustrated in FIG. 1. The controller 208 is connected to the respective components 202 to 206 through the bus 210, and provides the centralized control of the respective components.

The following will explain the respective components.

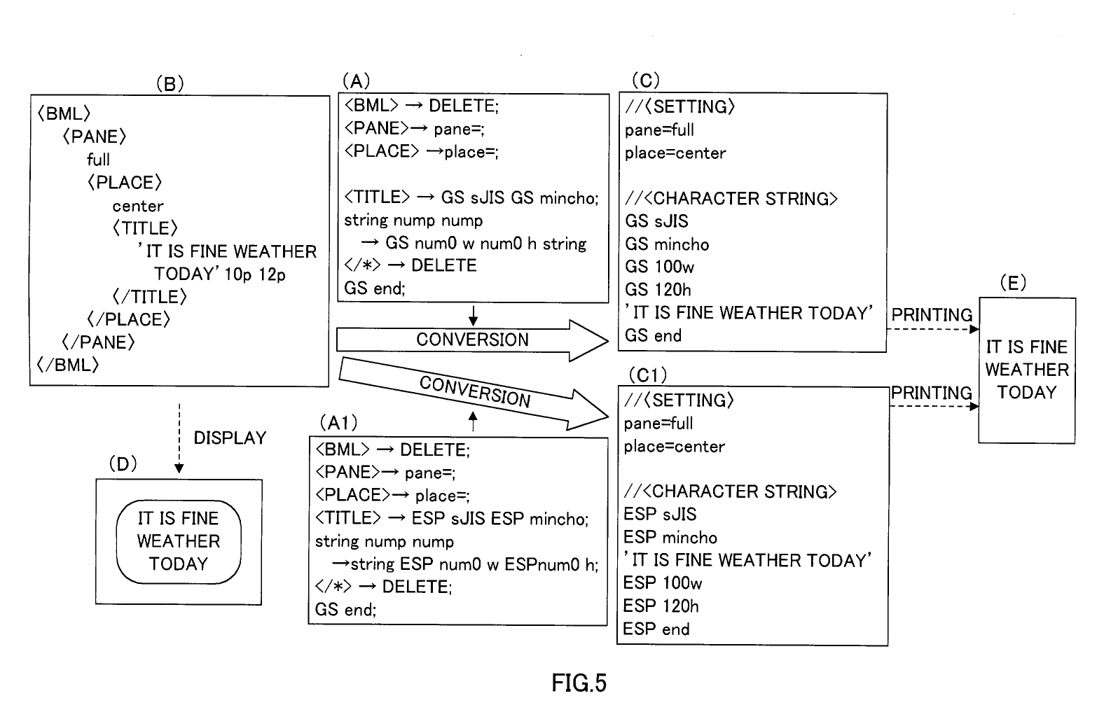

The conversion rule storing section 202 pre-stores the conversion rule information. The conversion rule information is one that converts BML data into printing XML data, which is printable by the printer 200, as mentioned above. More specifically, this is provided in the form of a style sheet that contains a description format of XML data. Data is described on the style sheet using a language for a style sheet in a predetermined format (for example, XSLT). A part (A) in FIG. 5 to be mentioned later shows one example of an XSLT style sheet for BML.

Preferably, the conversion rule information storing section 202 pre-stores more than one stock of conversion rule information corresponding to a plurality of kinds of data source XML data. For example, in consideration of the case where Internet TV becomes a data source, the Internet TV handles document data described in HTML (Hypertext Markup Language) (hereinafter referred to “HTML data”) format and BML data. For this reason, there are prepared conversion rule information for converting HTML data into XML data for printing (for example, XSLT style sheet for HTML) and conversion rule information for converting BML data into XML data for printing (for example, XSLT style sheet for BML). This makes it possible to connect a plurality of kinds of data sources (client apparatuses) or a data source (client apparatus) that can process a plurality of kinds of XML data by use of one printer.

More preferably, the conversion rule information storing section 202 stores a plurality of conversion rule information, which is the same kind and which has different conversion contents. For example, a plurality of conversion rule information, which is used to convert BML data into XML data for printing, and which differs in the kinds of fonts and sizes, and colors. Thus, a plurality of same kinds of conversion rule information, which has different conversion contents, is prepared, and a switch or selection of the conversion rule information is carried out, making it possible to change a “look and feel” of print output (types of fonts, sizes, colors, and the like). In other words, the description of style sheet is changed to vary the types of fonts, sizes, colors, etc., making it possible to express the same DTD contents in completely different format.

The printer engine 204 prints out printing data subjected to bit map decompression on printing paper. The printer engine includes a thermal transfer method (sublimation type and thermal melt type), a thermal method, an inkjet method, an electrophotographic method, etc., but the method is not particularly specified here.

The outer interface 206 is a module that connects the printer 200 and the receiver 100 to each other to allow mutual communication therebetween to be carried out, and this is the same kind of module as that of the outer interface 112 of receiver 110. Additionally, as described above, the connection between the printer 200 and the receiver apparatus 100 can be made using any connection system, for example, a cable system such as USB, IEEE 1394, etc., a wireless system such as Bluetooth, IEEE 802.11 standard, a peer to peer system, or a network connection system, etc as mentioned above.

The controller 208 includes the function of controlling the operation of the entire printer 200 where the respective components 202 to 206 are given centralized control. The controller 208 also includes the components of CPU, ROM, and RAM (any not shown), similar to the controller 114 of receiver 100.

The controller 208 has a syntactic parsing program, which is called XML parser, another program called layouter, and also a program called a rasterizer.

The XML parser provides parsing (structural analysis) to printing XML data from the receiver 100, and outputs a document object. This document object is a structured document in which a syntactical tree structure is formed according to a tag in the original XML data. Namely, the controller 208 parses XML data for printing from the receiver 100 using this XML parser, and generates data of the tree structure that reflects a hierarchical structure of XML, which is called DOM (document object model) tree, and a CSS property with printing style information sourced from the corresponding XML data for printing.

Moreover, the controller 208 performs layout composition processing in which printing positions of characters and image objects are decided from the DOM tree and CSS property generated by the XML parser, and generates layout data using the layouter.

Still moreover, the rasterizer decompress characters and image data to bitmaps (raster data) (bitmap decompression processing), and outputs the results to the printer engine 204. In other words, by bitmap decompression processing of the rasterizer, the controller 208 rasterizes character data using outline font data stored in the corresponding controller 208, and converts image objects into bitmaps. Print data subjected to bit map decompression is output to the printer engine 204.

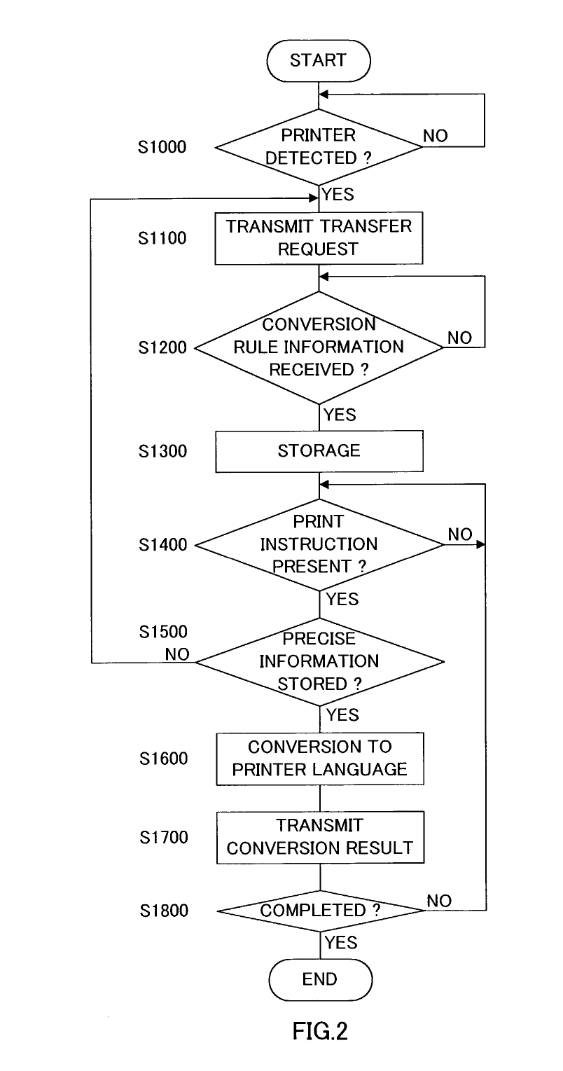

An explanation will be next given of actions of the receiver 100 using the flowchart shown in FIG. 2. Additionally, the flowchart shown in FIG. 2 is stored in ROM of the controller 114 as a control program, and is executed by CPU.

First, in step S1000, it is determined whether or not the printer 200 has been detected based on a signal from the printer detecting section 108. More specifically, it is determined whether or not the printer 200 is connected to the corresponding receiver 100, or it is determined whether or not power of the printer 200 connected to the corresponding receiver 100 is turned on. If the detection of printer 200 is obtained as a result of this determination (S1000: YES), the operation goes to step S1100. If no detection of printer 200 is obtained (S1000: NO), the operation is in a standby state.

Then, in step S1100, the receiver 100 makes a request of the printer 200 to transfer conversion rule information (for example, XSLT style sheet for BML), which is used to convert received BML data (multimedia contents) into printing XML data, to the receiver 100 via the outer interface 112.

Then, in step S1200, it is determined whether or not conversion rule information is received from the printer 200 via the outer interface 112. If conversion rule information is received as a result of determination (S1200: YES), the operation goes to step S1300. If no conversion rule information is received (S1200: NO), the operation is in a standby state.

Instep S1300, conversion rule information received in step S1200 is temporarily stored (overwritten and saved) in the conversion rule information storing section 104.

After that, in step S1400, it is determined whether or not an instruction to print is input from a user via the input operation interface 110. If the instruction to print is input as a result of the determination (S1400: YES), the operation goes to stepS1500. If no instruction to print is input (S1400: NO), the operation is in a standby state.

In step S1500, it is determined whether or not accurate conversion rule information is stored in the conversion rule information storing section 104. This is because a transfer request relating to conversion rule information is sent to the printer 200 again before carrying out processing at the language converting section 106 in the case where accurate conversion rule information is not yet downloaded from the printer 200 for some reason or other at the time of printing BML data (for example, as in such a case where not XSLT style sheet for BML but XSLT style sheet for HTML is downloaded). If accurate conversion rule information is stored in the conversion rule information storing section 104 as a result of this determination (S1500: YES), the operation goes to step S1600. If no accurate conversion rule information is stored in the conversion rule information storing section 104 (S1500: NO), the operation goes back to step S1100 based on the rules of above-mentioned routine, and a transfer request relating to conversion rule information is re-sent to the printer 200.

In step S1600, the language converting section 106 converts received BML data of digital broadcast contents into printing XML data, which is printable by the printer 200, using the XSLT processor and conversion rule information (XSLT style sheet for BML) temporarily stored in the conversion rule information storing section 104. At this time, as mentioned above, audio and music having no needs to be printed, and a script that defines the interactive operations only are deleted during processing of the XSLT processor. The moving picture objects are replaced with still picture objects, and the style sheet for a screen display is converted into one, which is appropriate for printing and which is suitable for the capability of printer 200.

Then, in step S1700, the conversion result (XML data for printing) obtained in step S1600 is transmitted to the printer 200 via the outer interface 112.

After that, in step S1800, it is determined whether or not the operation should be ended. More specifically, for example, it is determined whether or not power of the receiver 100 is turned off. Or, it is determined whether or not the connection between the receiver 100 and the printer 200 is disengaged. Or, it is determined whether or not power of the printer 200 connected to the corresponding apparatus 100 is turned off. If the operation is ended as a result of this determination (S1800: YES), the series of processing is ended. If the operation is not ended (S1800: NO), the operation goes back to step S1400, the receiver 100 waits for a next instruction to print.

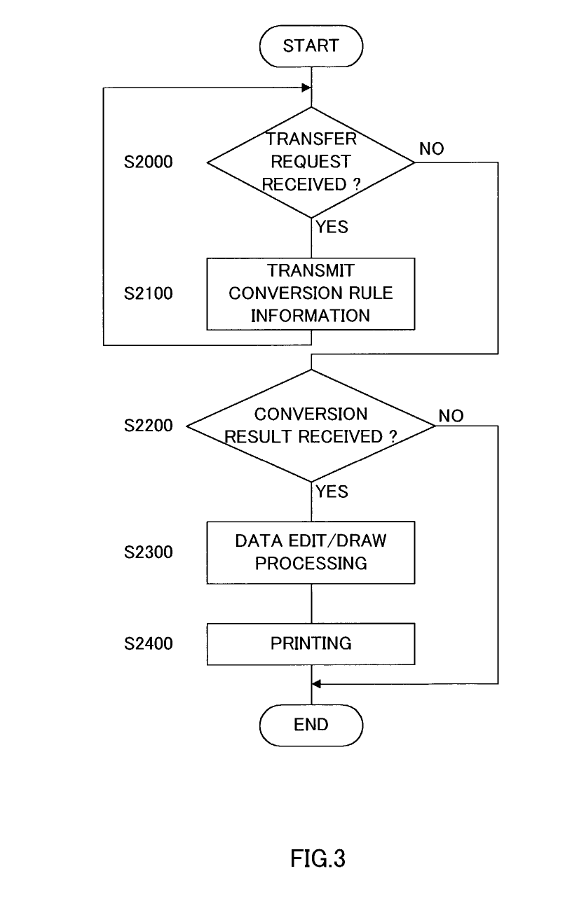

An explanation will be next given of the actions of printer 200 having the aforementioned configuration by use of the flowchart shown in FIG. 3. Additionally, the flowchart shown in FIG. 3 is stored in ROM of the controller 208 as a control program, and is executed by CPU.

First, in step S2000, it is determined whether or not a transfer request relating to conversion rule information is received from the receiver 100 via the outer interface 206. This transfer request includes a re-transmit request (see step S1500 in FIG. 2). If the transfer request relating to conversion rule information is received as a result of this determination (S2000: YES), the operation goes to step S2100. If no transfer request for conversion rule information is received (S2000: NO), the operation goes to step S2200.

In step S2100, designated conversion rule information (XSLT style sheet for BML in the above example) is extracted from the conversion rule information storing section 202, and extracted conversion rule information is sent to the receiver 100 via the outer interface 206, and then the operation goes back to step S2000.

In step S2200, it is determined whether or not XML data for printing (conversion result) is received from the receiver 100 via the outer interface 206. If the XML data for printing is received from the receiver 100 as a result of this determination (S2200: YES), the operation goes to step S2300. If no XML data for printing is received (S2200: NO), it is determined that the operation is in a standby state or an error state, and the operation is ended.

In step S2300, data edit/draw processing is performed to printable XML data received in step S2200 by the XML parser, layouter, and rasterizer. More specifically, the XML parser parses printing XML data from the receiver 100, and generates data of the tree structure that reflects a hierarchical structure of XML, which is called DOM tree, and a CSS property with printing style information. Then, the layouter performs composition processing in which printing positions of characters and image objects are decided from the DOM tree and CSS property generated by the XML parser, and generates layout data. After that, the rasterizer rasterizes character data and converts image objects into bitmaps to generate print data subjected to bitmap decompression and to output the results to the printer engine 204.

Then, in step S2400, print data subjected to bitmap decompression generated in step S2300 is printed on printing paper, and the series of processing is ended.

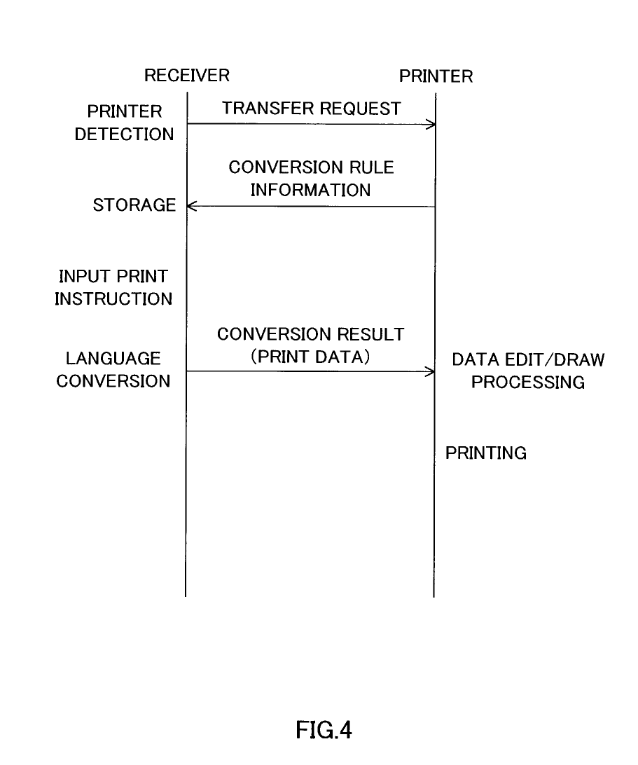

An explanation will be next given of processing procedures executed when digital broadcast contents (multimedia data) received in the receiver 100 a reprinted by the printer 200 using an operation sequence view shown in FIG. 4 and an explanatory view shown in FIG. 5. Here, FIG. 5 is a view specifically showing one example of language conversion, a part (A) in FIG. 5 is an example of a description of conversion rule information (XSLT style sheet for BML), a part (B) in FIG. 5 is an example of a description using a language (BML) for receiver 100, a part (C) in FIG. 5 is an example of a description using a language (XML for printing) for printer 200, a part (D) in FIG. 5 is an example of screen display, which corresponds to the part (B) in FIG. 5, in the receiving system, and a part (E) in FIG. 5 is an example of printing result, which corresponds to the part (C) in FIG. 5, using printer 200. Moreover, a part (Al) in FIG. 5 is an example of a description of conversion rule information for a printer, which is a different model from the printer that uses conversion rule information of the part (A) in FIG. 5, and a part (Cl) in FIG. 5 is an example of a description using a language (XML for printing) for the printer of different model. Additionally, in the explanation given below, step numbers in FIGS. 2 and 3 are cited where necessary.

When the printer 200 is connected to the receiver 100 or power of the printer 200 connected to the receiver 100 is turned on, the receiver 100 detects this state (S1000: YES) and sends the printer 200 a transfer request relating to conversion rule information (for example, XSLT style sheet for BML: see the part (A) in FIG. 5) that is used to convert received BML data (multimedia contents) (see the part (B) in FIG. 5) into XML data for printing (see the part (C) in FIG. 5) (S1100).

Then, when receiving the transfer request (S2000: YES), the printer 200 extracts designated conversion rule information (XSLT style sheet for BML) from the conversion rule information storing section 202 and transmits the extracted conversion rule information to the receiver 100 (S2100).

After that, when receiving conversion rule information (S1200: YES), the receiver 100 temporarily stores received conversion rule information inside the conversion rule information storing section 104 (S1300).

Then, when an instruction to print is input from the user (S1400: YES), the receiver 100 checks that accurate conversion rule information is stored in the conversion rule information storing section 104 (S1500: YES), and converts BML data of received digital broadcast contents (see the part (B) in FIG. 5) into XML data for printing, which is printable by the printer 200 (see the part (C) in FIG. 5), using the XSLT processor and the conversion rule information (see the part (A) in FIG. 5) (S1600). Then, the receiver 100 transmits a conversion result (XML data for printing) as print data to the printer 200 (S1700).

After that, when receiving the conversion result (XML data for printing)(S2000: N0, S2200: YES), the printer 200 provides data edit/draw processing to the received XML data for printing using the XML server, layouter, and rasterizer to generate print data subjected to bitmap decompression (S2300). Then, the generated printing data subjected to bitmap decompression is printed on printing paper (S2400) (see the part (E) in FIG. 5).

In this way, according to the information printing system of this embodiment, it is possible for the printer 200 to print the digital broadcast contents (multimedia data described in BML) received by the receiver 100 in an output form, which is suitable for printing, with a relatively simple structure without installing the printer driver onto the receiver 100. Additionally, at this time, for example, another conversion rule information shown in the part (A1) in FIG. 5 is used in place of conversion rule information shown in the part (A) in FIG. 5, making it possible to carry out conversion to XML data for printing to the printer of a different model that interprets a different printing language shown in the part (C1) in FIG. 5.

(Embodiment 2)

Embodiment 2 shows a case in which print data in place of multimedia data is printed in the digital broadcast, namely, when data (print data) for the purpose of printing in the digital broadcast is broadcasted, the print data is printed. In the digital broadcast, it is possible to broadcast arbitrary data and receive it besides multimedia contents (described in BML) aiming at the display and reproduction in the receiving system. Here, as one example, it is assumed that print data is generated using HTML, which is used to describe a Web page, to digitally broadcast print data generated. In addition, various kinds of file-generating tools in HTML format have come on the market and some of application software of personal computers can store generated data in HTML format. Accordingly, the use of such application software makes it easy to generate HTML data for printing to be broadcasted in the digital broadcast.

The information printing system according to Embodiment 2 has the same basic configuration as that of the information printing system corresponding to Embodiment 1 shown in FIG. 1, and the same basic operations as those of the receiver and the printer as those of the information printing system corresponding to Embodiment 1. Explanation of some sections in FIG. 4 common to the sections in FIG. 1 is omitted, and only different sections are explained with reference to FIG. 4. Additionally, in the explanation given below, reference numerals in FIG. 1 and step numbers in FIGS. 2 and 3 are cited where necessary.

When the printer 200 is connected to the receiver 100 or the printer 200 connected to the receiver 100 is turned on, the receiver 100 detects this state (S1000: YES) andsendstheprinter200 a transfer request relating to conversion rule information (for example, XSLT style sheet for HTML) that is used to convert received HTML data (print data) into XML data for printing (S1100).

Then, when receiving the transfer request (S2000: YES), the printer 200 extracts designated conversion rule information (XSLT style sheet for HTML) from the conversion rule information storing section 202 and transmits the extracted conversion rule information to the receiver 100 (S2100).

Additionally, at this time, if the printer 200 has a plurality of kinds of XSLT style sheets (for example, for BML and HTML), all XSLT style sheets are downloaded onto the receiver 100 at one time, so that they may be stored temporarily. However, in the case where a storing area of the receiver 100 is insufficient, an XSLT style sheet, which is used when processing by the XSLT processor is needed, may be downloaded from the printer 200.

After that, when receiving conversion rule information (S1200: YES), the receiver 100 temporarily stores received conversion rule information to the conversion rule information storing section 104 (S1300). Then, when an instruction to print is input from the user (S1400: YES), it is checked that accurate conversion rule information is stored in the conversion rule information storing section 104 (S1500: YES). Thereafter, HTML data, which are contents received and which is generated for printing, is converted into XML data for printing by use of the XSLT processor and the conversion rule information (S1600). Then, the receiver 100 transmits the conversion result (XML data for printing) to the printer 200(S1750).

Processing by the printer 200 afterward is the same as that of Embodiment 1. More specifically, when receiving the conversion result (XML data for printing) (S2000: NO, S2200: YES), the printer 200 provides data edit/draw processing to the received XML data for printing to generate print data subjected to bitmap decompression (S2300). Then, the generated print data subjected to bitmap decompression is printed on printing paper (S2400).

In this way, according to the information printing system of this embodiment, it is possible for the printer 200 to print the digital broadcast contents (print data described in HTML) received by the receiver 100 in an output form, which is suitable for printing, with a relatively simple structure without installing the printer driver onto the receiver 100.

(Embodiment 3)

Embodiment 3 shows a case in which printing conditions are set by the receiver when digital broadcast contents received by the receiver are printed. Here, the term “printing conditions” is defined as the setting of various kinds in connection with print output, and items of the printing conditions include, for example, the number of printing paper, paper size, adjustment level (coloring, dark and light), both sides/one side, presence or absence of sorting, magnification (expansion/reduction), N-in-i (function of printing N pages in one page), etc. Additionally, items to be set are different from one printer to another.

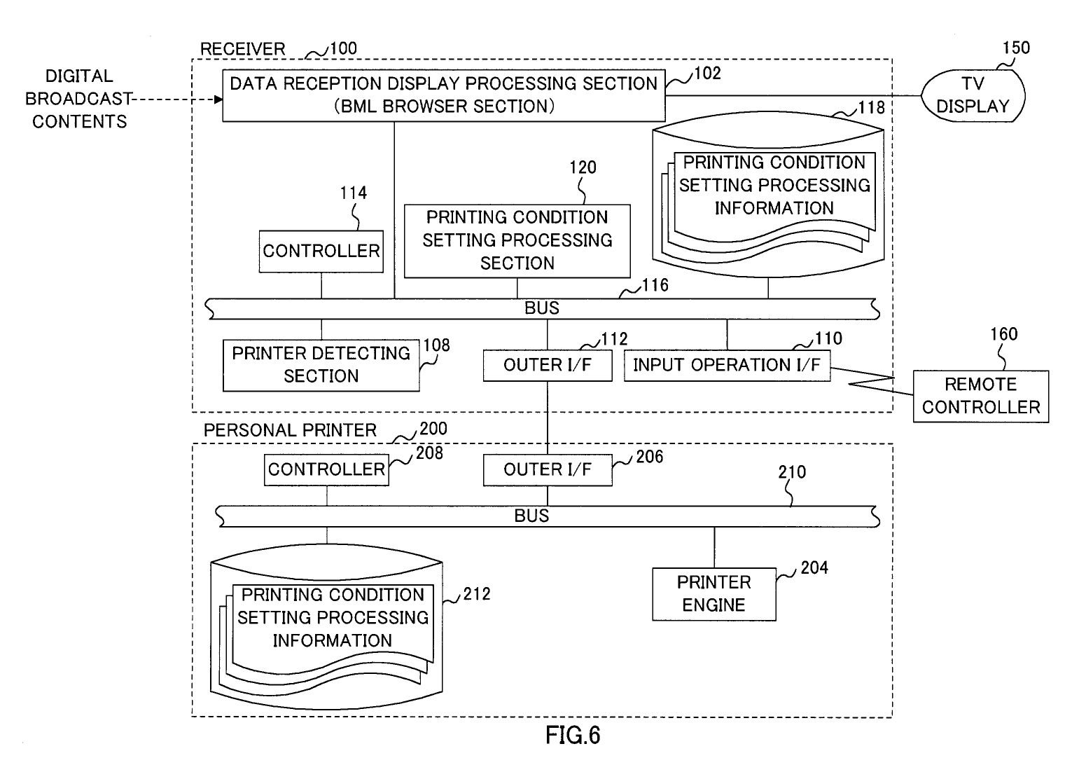

FIG. 6 is a block diagram showing the configuration of an information printing system according to Embodiment 3 of the present invention. In addition, the information printing system of FIG. 6 has the same basic configuration as that of the information printing system corresponding to Embodiment 1, and regarding the same sections as those of the first embodiment, the same reference marks as those of FIG. 1 are added to the corresponding sections of FIG. 6, and the specific explanation is omitted.

In the case where a data source is a personal computer, the setting of printing conditions can be carried out from the personal computer using a GUI (Graphical User Interface), which is controlled by a printer driver installed onto the personal computer. However, as mentioned above, since OS installed in the apparatus and CPU used therein vary from one manufacturer to another, the digital broadcast receiver cannot implement the method in which the printer driver is installed, unlike the personal computer.

For this reason, according to this embodiment, in order to make it possible to set the printing conditions whose items to be set are different depending on the model of the printer to be used by the user's input operation from the receiving system side, the following configuration is provided. Namely, in the printer 200, there is pre-stored printing condition setting processing information (printing condition setting processing information for BML), which is described in BML that is a markup language which is able to be processed by the receiver 100, and which includes a script that is used when the receiver 100 sets the printing conditions to the corresponding printer 200. The printing condition setting processing information is transferred to the receiver 100 from the printer 200 with given timing. Based on the transferred printing condition setting processing information, the receiver 100 controls the entire user interfaces such as GUI, remote controller, etc., and sets a printing condition according to the user's input operation to transmit the setting result (set printing condition) to the printer 200.

For this reason, the printer 200 includes a printing condition setting processing information storing section 212 in addition to the printer engine 204, outer interface 206, controller 208, and bus 210 as illustrated in FIG. 6.

The printing condition setting processing information storing section 212 pre-stores printing condition setting processing information for BML. The printing condition setting processing information for BML is described in BML that is the markup language, which is able to be processed by the receiver 100, and includes the script that is used when the receiver 100 sets the printing condition to the corresponding printer 200 as mentioned above. More specifically, it includes GUI screen information for setting the printing condition described in BML and the description of script, which instructs the operation of GUI using the remote controller 160 of receiver 100 and the transmission of set data to the printer 200.

Preferably, with consideration given to a case of connection with the client apparatus having HTML browser mounted thereon, the printing condition setting processing information storing section 212 stores printing condition setting processing information described in HTML (printing condition setting processing information for HTML) in addition to printing condition setting processing information for BML.

While, the receiver 100 includes a printing condition setting processing information storing section 118 and a printing condition setting processing section 120 in addition to the data reception display processing section 102, printer detecting section 108, input operation interface 110, outer interface 112, controller 114, and bus 116 as illustrated in FIG. 6.

The printing condition setting processing information storing section 118 temporarily stores printing condition setting processing information transferred from the printer 200.

The printing condition setting processing section 120 controls the user interfaces (screen of GUI and the action of input operation) based on printing condition setting processing information temporarily stored in the printing condition setting processing information storing section 118. More specifically, the printing condition setting processing section 120 controls the BML browser section (data reception display processing section) 102 and input operation interface 110 to cause the TV display 150 to display the GUI screen for printing condition setting, and sets a printing condition in accordance with the user's input using the remote controller 160. The GUI screen for printing condition setting is displayed by the BML browser, making it possible to input the printing condition setting by use of the remote controller 160 as viewing the GUI screens. Moreover, change inputs on the GUI screen entered using the remote controller 160 is carried out by processing a predetermined script described in the printing condition setting processing condition. Script processing at the printing condition setting processing section 120 is to be executed by a given program (script execution program).

Additionally, since the aforementioned script processing function relating to the GUI screen and the action of control is needed when BML data of digital broadcast contents is displayed/reproduced, the function is provided on the receiver. Among the script processing at the printing condition setting processing section 120, processing needed additionally in order to set a printing condition, is to execute the script, which mandates an action to transmit information of the printing condition set or selected, to the printer 200.

The following will specifically explain the script execution program, which is needed additionally in order to set the printing condition.

The script execution program to be added has a function of converting a set value, which is set or input to a certain setting item by the user, into a combination of a setting command, which corresponds to the setting item and which can be interpreted/executed by the printer 200, and its argument to transmit information subjected to the conversion to the printer 200. In connection with this point, such a burdensome task that a web server, which has a CGI (Common Gateway Interface), initiated at the printer 200, was conventionally needed to reflect the script execution result in the printer 200. However, addition of the script execution program to the print condition setting processing section 120 makes it possible to directly transmit the setting command, which can be interpreted/executed by the printer 200, to the printer 200 from the receiver 100. This makes it possible to reduce communication processing, which is necessary for printing condition setting, and program processing at the printer 200.

Moreover, in printing condition setting processing information for BML, a pre-described script selects a setting command corresponding to the setting item selected or input by the user. The script execution program selects the setting command corresponding to the setting item selected or input by the user based on the above description included in the printing condition setting processing information. This makes it possible to derive the setting item and the corresponding setting command from printing condition setting processing information for BML. Consequently, it is unnecessary to preset the setting command between the script execution program stored in the receiver 100 and the printer 200 to make it possible to absorb printer model dependence of the setting command.

Moreover, since the printing condition normally includes a plurality of setting items, the script execution program is structured such that a setting command, which can be interpreted and executed by the printer 200, is generated from each setting item and its setting value and the setting commands corresponding to the respective setting items are put into one data row and the result is transmitted to the printer 200. This eliminates the need for preparing the script execution program for each setting item to make it possible to provide a flexible script execution program that is adaptable to even a case where the printer setting item will be extended in the future.

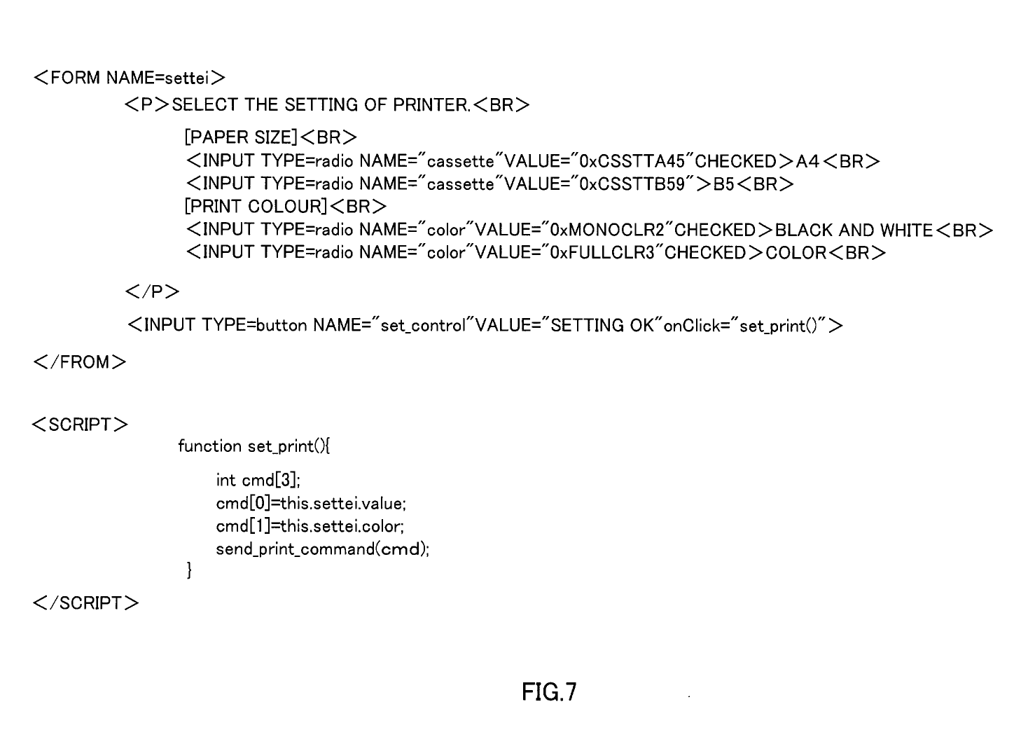

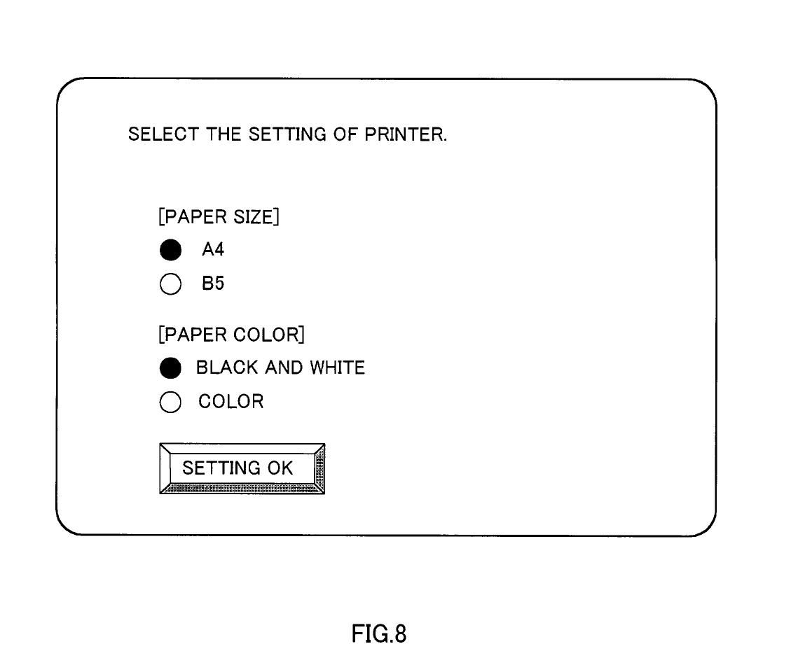

An explanation will be next given of the specific example using FIGS. 7 and 8. FIG. 7 is an example of a part of the description of printing condition setting processing information for BML sent from the printer 200. When this printing condition setting processing information is displayed using the browser of receiver 100, a screen, which is used to perform a print setting of the printer 200 as shown in FIG.8, is displayed. Here, when the user inputs the setting of paper size, etc. and depresses a setting OK button, a script function “set_print( )”, which is described in printing condition setting processing information, is called. Then, in the script function, a script function “send_print_command(cmd)”, which transmits the setting commands to the printer 200 at one time, is called and executed. At this time, the setting command to be sent to the printer 200 is described beforehand in printing condition setting processing information in the form of “VALUE=“OxCSSTTA45”” and the like. In the script function “send_print_command(cmd)”, a setting command data row “cmd [] ” where these setting commands are suitably selected and complied is transmitted to the printer 200.

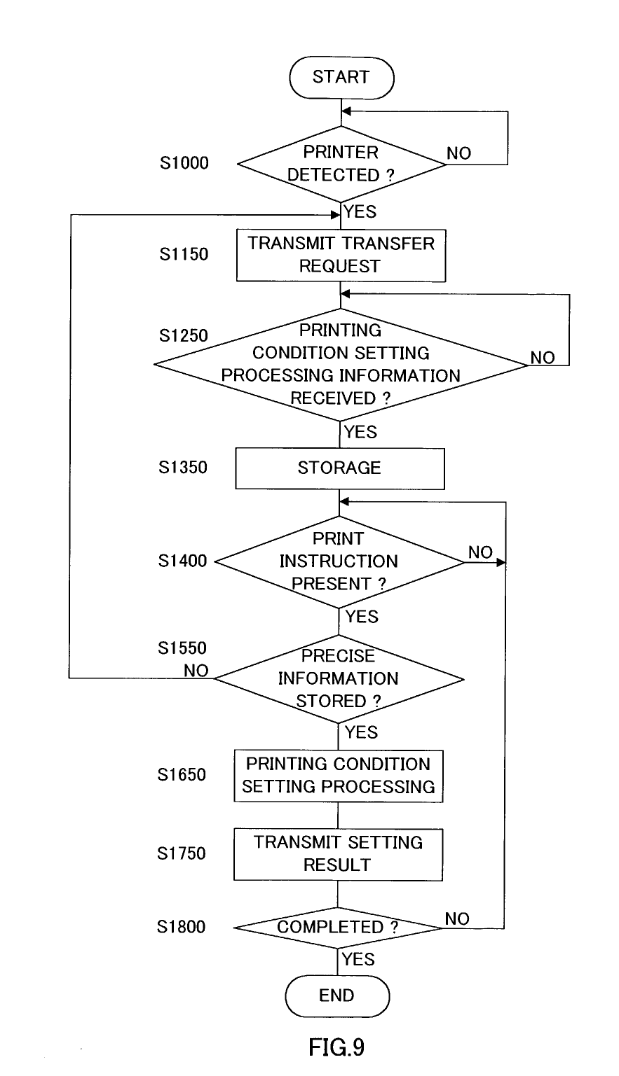

An explanation will be next given of the actions of the receiver 100 having the aforementioned configuration using the flowchart shown in FIG. 9. In addition, the flowchart shown in FIG. 9 is stored in ROM of the controller 114 as a control program, and executed by CPU.

In this embodiment, as shown in FIG. 9, step S1150, step S1250, step S1350, step S1550, step S1650, and step S1750 are inserted to the flowchart shown in FIG. 2, and stepS1100, stepSl200, stepS1300, stepSl500, stepS1600, and step S1700 are deleted.

Step S1000 is the same as the step of the flowchart of FIG. 2, and the explanation is omitted. However, in this embodiment, when the printer 200 is detected (S1000: YES), the operation goes to step S1150.

Then, in step S1150, the receiver 100 makes a request of the printer 200 to transfer printing condition setting processing information for BML, which is used to set the printing condition by the receiver 100, to the receiver 100 via the outer interface 112.

Then, in step S1250, it is determined whether or not printing condition setting processing information is received from the printer 200 via the outer interface 112. If printing condition setting processing information is received as a result of determination (S1250: YES), the operation goes to step S1350. If no printing condition setting processing information is received (S1250: NO), the operation is in a standby state.

In step S1350, printing condition setting processing information received in step S1250 is temporarily stored (overwritten and saved) in the printing condition setting processing information storing section 118.

Step S1400 is the same as the step shown in the flowchart of FIG. 2, and the explanation is omitted. However, in this embodiment, if the instruction to print is input from the user (S1400: YES), the operation goes to step S1550.

In step S1550, it is determined whether or not accurate printing condition setting processing information is stored in the printing condition setting processing information storing section 118. This is because a transfer request relating to printing condition setting processing information is sent to the printer 200 again before carrying out processing at the printing condition setting processing section 120 in the case where accurate printing condition setting processing information is not yet downloaded from the printer 200 for some reason or other at the time of printing BML data (for example, as in such a case where not printing condition setting processing information for BML but printing condition setting processing information for HTML is downloaded). If accurate printing condition setting processing information is stored in the printing condition setting processing information storing section 118 as a result of this determination (S1550: YES), the operation goes to step S1650. If no accurate printing condition setting processing information is stored in the printing condition setting processing information storing section 118 (S1550: NO), the operation goes back to step S1150 based on the rule of above-mentioned steps, and re-sends a transfer request relating to printing condition setting processing information to the printer 200.

In step S1650, the printing condition setting processing section 120 carries out the script processing for setting the printing condition by use of printing condition setting processing information for BML, which is temporarily stored in the printing condition setting processing storing section 118, so that the user interfaces (screen of GUI and the action of input operation) are controlled to set the printing condition in accordance with the user's input operation.

Then, instepS1750, the setting result (set printing condition) obtained in step S1650 is transmitted to the printer 200 via the outer interface 112. Step S1800 is the same as the step shown in the flowchart of FIG. 2, and the explanation is omitted.

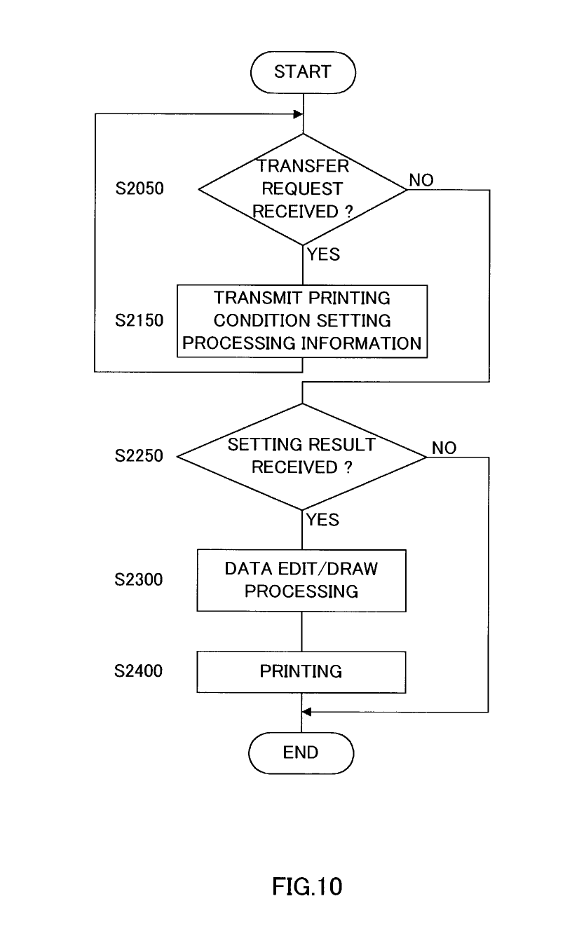

An explanation will be next given of the actions of the printer 200 having the aforementioned configuration using the flowchart shown in FIG. 10. In addition, the flowchart shown in FIG. 10 is stored in ROM of the controller 114 as a control program, and executed by CPU.

In this embodiment, as shown in FIG. 10, step S2050, step S2150, and step S2250 are inserted to the flowchart shown in FIG. 3, and step S2000, step S2100, and step S2200 are deleted.

First, in step S2050, it is determined whether or not a transfer request relating to printing condition setting processing information is received from the receiver 100 via the outer interface 206. This transfer request includes a re-transmit request (see step S1550 in FIG. 7). If the transfer request relating to printing condition setting processing information is received as a result of this determination (S2050: YES), the operation goes to step S2150. If no transfer request for printing condition setting processing information is received (S2050: NO), the operation goes to step S2250.

In step S2150, designated printing condition setting processing information for BML is extracted from the printing condition setting processing storing section 212, and extracted printing condition setting processing information is sent to the receiver 100 via the outer interface 206, and then the operation goes back to step S2050.

In step S2250, it is determined whether or not the setting printing condition (setting result) is received from the receiver 100 via the outer interface 206. If the setting printing condition is received from the receiver 100 as a result of this determination (S2250: YES), the operation goes to step S2300. If no setting printing condition is received (S2250: NO), it is determined that the operation is in a standby state or an error state, and the operation is ended.

Step S2300 and step S2400 are the same as the step of the flowchart shown in FIG. 3, and the explanation is omitted.

However, in this embodiment, data edit processing that reflects the setting printing condition received in step S2250 is carried out at the time of data edit processing in step S2300. Additionally, here, as a precondition, it is assumed that printing data, which corresponds to the corresponding setting printing condition, is sent to the printer 200 from the receiver with appropriate timing.

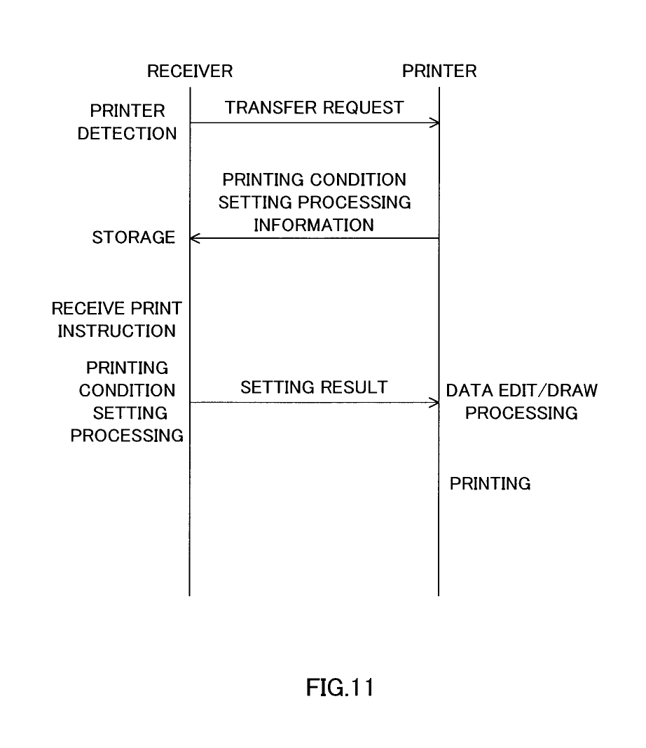

An explanation will be next given of processing procedures executed where digital broadcast contents received in the receiver 100 is printed by the printer 200 using an operation sequence view shown in FIG. 11. Additionally, in the explanation given below, step numbers in FIGS. 9 and 10 are cited where necessary.

When the printer 200 is connected to the receiver 100 or power of the printer 200 connected to the receiver 100 is turned on, the receiver 100 detects this state (S1000: YES) and sends the printer 200 a transfer request relating to printing condition setting processing information for BML, which is used to set the printing condition at the receiver 100 (S1150).

Then, when receiving the transfer request (S2050: YES), the printer 200 extracts designated printing condition setting processing information for BML from the printing condition setting processing information storing section 212 and transmits the extracted printing condition setting processing information to the receiver 100 (S2150).

After that, when receiving printing condition setting processing information (S1250: YES), the receiver 100 temporarily stores received printing condition setting processing information to the printing condition setting processing information storing section 118 (S1350).

Then, when an instruction to print is input by the user (S1400: YES), the receiver 100 checks that accurate printing condition setting processing information is stored in the printing condition setting processing information storing section 118 (S1550: YES). Thereafter, the receiver 100 carries out the script processing for setting a printing condition using the printing condition setting processing information to control the user interfaces (screen of GUI and the action of input operation) to set the printing condition in accordance with the user's input operation (S1650) and to transmit the setting result (set printing condition) to the printer 200 (S1750).

After that, when receiving the setting result (set printing condition) (S2050: NO, S2250: YES), the printer 200 carries out data edit processing that reflects received setting printing condition and draw processing to generate print data subjected to bitmap decompression (S2300). Then, the generated print data subjected to bitmap decompression is printed on printing paper (S2400).

In this way, according to the information printing system of this embodiment, the receiver 100 can set the printing condition that depends on the printer 200 and the printer 200 can print the digital broadcast contents received by the receiver 100 in an output form, which is suitable for printing, with a relatively simple structure without installing the printer driver onto the receiver 100.

Additionally, it is possible to set the printing condition, which is different for each model of printer 200, without changing software of the receiver 100, and it is also possible to reduce processing task loads for setting the printing condition at the receiver 100.

Additionally, in this embodiment, timing with which the receiver 100 receives printing condition setting processing information from the printer 200 is the point in time when the printer 200 is connected to the receiver 100, or time when the power of the printer 200 connected to the receiver 100 is turned on, however, the present invention is not limited to this. For example, timing may be the point in time when printing is actually carried out (when an instruction to print is input by the user) or time when the user of receiver 100 inputs the setting of printing condition to the receiver 100.

(Embodiment 4)

Embodiment 4 shows a case in which a data source (client apparatus) is an Internet terminal in place of the digital broadcast receiver 100 of Embodiments 1 to 3.

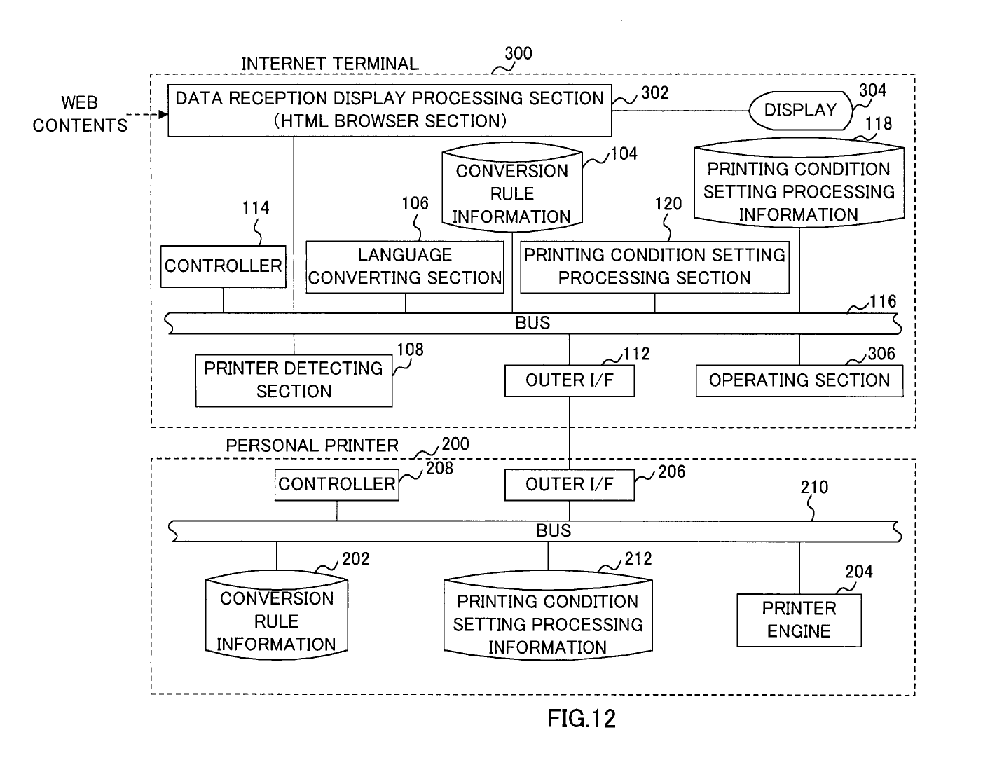

FIG. 12 is a block diagram showing the configuration of the information printing system according to Embodiment 4 of the present invention. In addition, this information printing system has the same basic configuration as that of the information printing system corresponding to Embodiment 1 shown in FIG. 1 and that of the information printing system corresponding to Embodiment 3 shown in FIG. 6. The same reference marks as those of FIGS. 1 and 6 are added to the corresponding sections of FIG. 12, and the specific explanation is omitted.

Namely, Embodiment 1 relates to the function of converting the language used in the client apparatus into the language for printer, and Embodiment 3 relates to the function of carrying out the setting of printing condition by the user's operation at the client apparatus. Both functions can coexist in the same system. However, they were explained separately in Embodiments 1 and 3 for the sake of convenience. However, this embodiment hereinafter explains a case, as an example, in which two functions (language conversion function and printing condition setting function) coexist in the same information printing system.

The information printing system shown in FIG. 12 is a system for printing Web contents obtained by making connection to the Internet. The information printing system includes an Internet terminal 300, which downloads Web contents, and the printer 200. The Web contents are described in the markup language, which is called HTML. Moreover, the printer 200 is connected to the Internet terminal 300, and receives data for printing from the Internet terminal 300 to perform printing.

The Internet terminal 300 includes an HTML browser section (data reception display processing section) 302 in place of the BML browser section (data reception display processing section) 102 in the receiver 100, a built-in display 304 in place of the TV display 150 connected to the receiver 100, and an operating section 306 in place of the input operation interface 110 in the receiver 100, respectively. Moreover, in the Internet terminal 300, the remote controller is not used unlike the receiver 100.

The data reception display processing section 302 carries out processing for receiving Web contents (HTML data), storing them and displaying them on the display 304. This processing is executed by a processing program, which is called HTML browser. In order to display the Web contents on the display 304, this HTML browser is normally mounted on the Internet terminal 300.

The operation section 306 is a module that processes the input operation done by the user. For example, the operation section 306 includes an operation button/switch (not shown), which is used when the user carries out manual operation. Moreover, the operation section 306 may include a display panel for displaying the contents set currently or an LED indicator though they are not shown. Still moreover, the operation section 306 may include a pointing device such as a mouse, a keyboard, etc., though they are not shown.

Additionally, on the Internet terminal 300, there is mounted an XSLT processor, which is a program for converting the description of a certain XML application into the description of another XML application, similar to the case of the receiver 100.

Moreover, the XSLT style sheet, which is used to perform conversion from HTML into XML by the XSLT processor of Internet terminal 300, is pre-stored in the conversion rule information storing section 202 provided in the printer 200 connected to the Internet terminal 300, similar to the case of the receiver 100.

In this case, printing condition setting processing information for HTML, which is described in HTML that is the markup language to be processed by the Internet terminal 300, is stored in the printing condition setting processing information storing section 212 of the printer 200. This printing condition setting processing information for HTML includes GUI screen information for setting the printing condition described in HTML, and the description of script, which instructs the action of GUI using the pointing device and the keyboard provided within the configuration of the Internet terminal 300 and the transmission of setting data to the printer 200.

Still moreover, the script description contained in the printing condition setting processing information for HTML is processed with a designated program residing at the printing condition setting processing section 120 of the Internet terminal 300, so that the screen of GUI and the action of control are controlled. Among the script processing at the printing condition setting processing section 120, the script processing relating to the screen of GUI and the action of control is needed when Web contents are displayed and reproduced, and it is originally mounted on the Internet terminal 300.

Further, in connection with the language conversion function, the operations of the Internet terminal 300 with the aforementioned structure and the printer 200 are the same as those of the receiver 100 and printer 200 corresponding to Embodiment 1 shown in FIGS. 2 and 3. In connection with the printing condition setting function, they are same as the operations of the receiver 100 and printer 200 corresponding to Embodiment 3 shown in FIGS. 9 and 10. Therefore, explanation is omitted here.

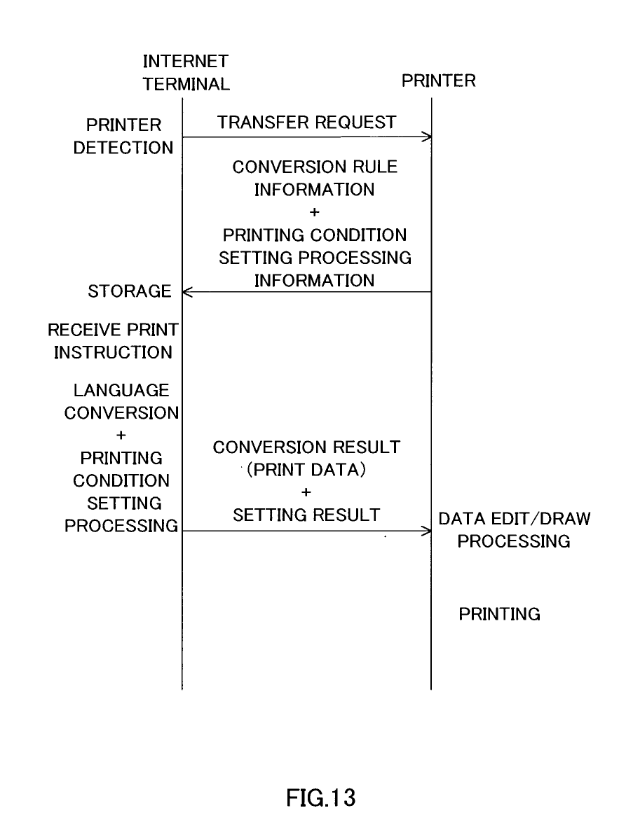

An explanation will be next given of procedures executed when Web contents received by the Internet terminal 300 are printed by the printer 200 (including procedures executed when the printing condition is set at the Internet terminal 300) using the operation sequence view shown in FIG. 13. Additionally, in the explanation given below, step numbers in FIGS. 2, 3, 9 and 10 are cited where necessary.

When the printer 200 is connected to the Internet terminal 300 or the power of the printer 200 connected to the Internet terminal 300 is turned on, the Internet terminal 300 detects this state (S1000: YES) and sends the printer 200 a transfer request relating to conversion rule information, which is used to convert received HTML data (Web contents) into XML data for printing (for example, XSLT style sheet for HTML), and printing condition setting processing information for HTML, which is used to set the printing condition at the Internet terminal 300 (S1100, S1150).

Then, when receiving the transfer request (S2000: YES), the printer 200 extracts designated conversion rule information (XSLT style sheet for HTML) from the conversion rule information storing section 202, on the one hand, and transmits the extracted conversion rule information to the Internet terminal 300 (S2100), and on the other hand, the printer 200 extracts designated printing condition setting processing information for HTML from the printing condition setting processing storing section 212, and transmits the extracted printing condition setting processing information to the Internet terminal 300 similarly (S2150).

After that, when receiving conversion rule information on the one hand (S1200: YES), the Internet terminal 300 temporarily stores received conversion rule information to the conversion rule information storing section 104 (S1300). When receiving printing condition setting processing information on the other hand (S1250: YES), the Internet terminal 300 temporarily stores received printing condition setting processing information in the printing condition setting processing information storing section 118 (S1350).

Then, when an instruction to print is input by a user (S1400: YES), the Internet terminal 300 checks that accurate conversion rule information is stored in the conversion rule information storing section 104 on the one hand (S1500: YES), and thereafter, the Internet terminal 300 converts HTML data of received Web contents into print XML data, which can be printed by the printer 200, using the XSLT processor and the conversion rule information (S1600), and transmits a conversion result (XML data for printing) to the printer 200 as print data (S1700). On the other, the Internet terminal 300 checks that accurate printing condition setting processing information is stored in the printing condition setting processing information storing section 118 (S1550: YES). Thereafter, script processing for setting the printing condition is carried out using the printing condition setting processing information, so that the user interfaces (screen of GUI and the action of input operation) are controlled to set the printing condition in accordance with the user's input operation (S1650), and also to transmit the setting result (set printing condition) to the printer 200 similarly (S1750).

After that, when receiving the conversion result (XML data for printing) and the setting result (set printing condition) (S2000: NO, S2200: YES, S2250: YES), the printer 200 provides data edit processing that reflects received setting printing condition and graphic processing to received XML data for printing to generate print data subjected to bitmap decompression (S2300). Then, the printer 200 prints generated print data subjected to bitmap decompression on printing paper (S2400).

In this way, according to the information printing system of this embodiment, the Internet terminal 300 can set the printing condition, which depends on the printer 200, and the printer 200 can print the Web contents (data described in HTML) received by the Internet terminal 300 in an output form with a relatively simple structure without installing the printer driver onto the Internet terminal 300.

Moreover, it is possible to set the printing condition, which is different for each model of printer 200, without changing software of the receiver 100, and it is also possible to reduce processing task loads for setting the printing condition at the Internet terminal 300.

Additionally, in this embodiment, timing with which the Internet terminal 300 receives printing condition setting processing information from the printer 200 is the point in time when the printer 200 is connected to the Internet terminal 300, or time when the power of the printer 200 connected to the Internet terminal 300 is turned on. However, the present invention is not limited to this. For example, timing may be the point in time when printing is actually carried out (when an instruction to print is input by the user) or time when the user of Internet terminal 300 inputs the setting of printing condition to the Internet terminal 300.

Furthermore, though this embodiment explains the case in which the Web contents received by the Internet terminal 300 is printed by the printer 200, an object to be printed is not limited to the Web contents. Another types of contents, which is data to be printed and which has been downloaded (download data for printing), may be possible to be printed. Printable data downloaded onto the Internet terminal 300 is normally described in HTML.

Moreover, the client apparatus, serving as a data source of the printer 200, may be a complex apparatus in which the receiver 100 and the Internet terminal 300 are combined, and the similar structure can be used in such a complex apparatus.

(Embodiment 5)

Embodiment 5 shows a case in which the data source (client apparatus) is a cellular phone, and the like (cellular phone/fixed phone/personal digital assistant), which are connectable to the Internet. Here, the following will explain a so-called cellular phone with an i-mode function as one example.

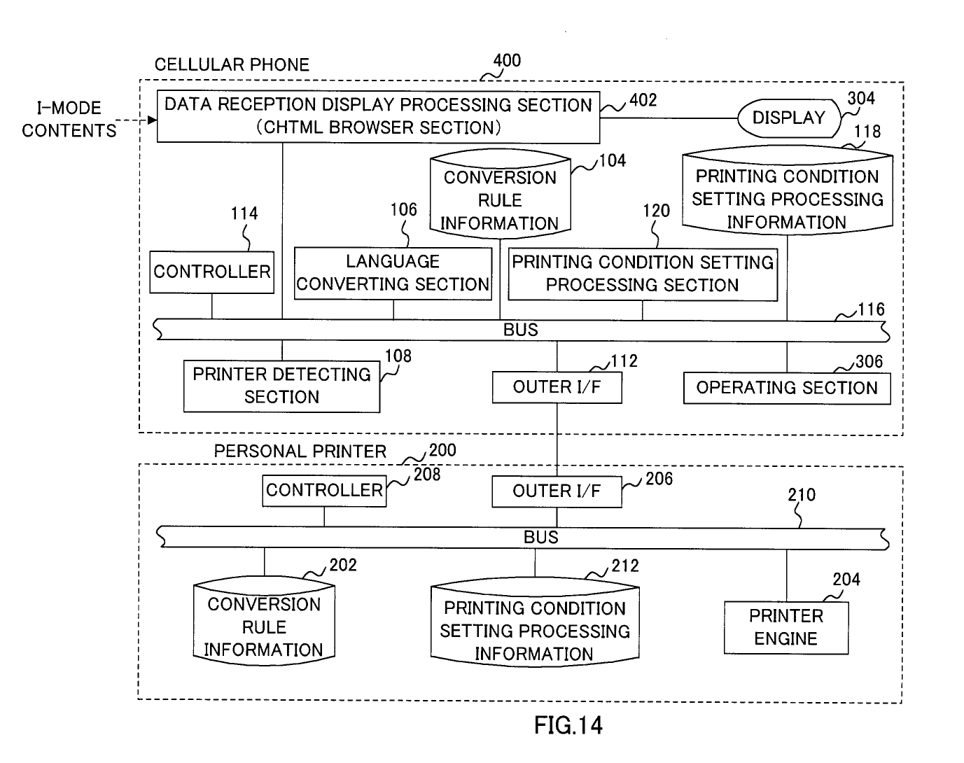

FIG. 14 is a block diagram showing the configuration of the information printing system according to Embodiment 5 of the present invention. Additionally, this information printing system has the same basic configuration as that of the information printing system corresponding to Embodiment 4 shown in FIG. 12, and the same reference marks as those of FIG. 12 are added to the corresponding sections of FIG. 14, and the specific explanation is omitted.

The information printing system shown in FIG. 14 is a system for printing i-mode contents that are obtained by making connection to the Internet. The information printing system includes a cellular phone with an i-mode function (hereinafter simply referred to as “cellular phone”) 400 and the printer 200. The i-mode contents are described in the markup language, which is called CHTML (Compact HTML). Moreover, the printer 200 is connected to the cellular phone 400 and receives data for printing from the cellular phone 400 to carry out printing.

The cellular phone 400 has a CHTML browser section (data reception display processing section) 402 in place of the HTML browser section (data reception display processing section) 302 of the Internet terminal 300.

The data reception display processing section 402 carries out processing for receiving i-mode contents (CHTML data), storing them and displaying them on the display 304. This processing is executed by a processing program, which is called CHTML browser. In order to display the Web contents on the display 304, this CHTML browser is normally mounted on the cellular phone 400.

Additionally, on the cellular phone 400, there is also mounted an XSLT processor, which is a program for converting the description of a certain XML application into the description of another XML application, similar to the cases of the receiver 100 and the Internet terminal 300.

The XSLT style sheet, which is used to perform conversion from CHTML into XML by the XSLT processor of cellular phone 400, is pre-stored in the conversion rule information storing section 202 provided in the printer 200 connected to the cellular phone 400, similar to the cases of the receiver 100 and the Internet terminal 300.

In this case, printing condition setting processing information for CHTML, which is described in CHTML that is the markup language which can be processed by the cellular phone 400, is stored in the printing condition setting processing information storing section 212 of the printer 200. This printing condition setting processing information for CHTML includes GUI screen information for setting the printing condition described in CHTML, and the description of script, which instructs both the action of GUI using the pointing device and the keyboard provided in the cellular phone 400 and the transmission of setting data to the printer 200.

The script description contained in the printing condition setting processing information for CHTML is processed by a designated program residing at the printing condition setting processing section 120 of the cellular phone 400, and thereby the screen of GUI and the operative action are controlled. Among the script processing conducted at the printing condition setting processing section 120, the script processing relating to the screen of GUI and the action of control is needed when the i-mode contents are displayed and reproduced, and therefore it is originally mounted on the cellular phone 400.

In connection with the operations of the cellular phone 400 with the aforementioned structure and the printer 200, they are the same as those of the Internet terminal 300. In connection with the language conversion function, they are the same as the operations of the receiver 100 and printer 200 corresponding to Embodiment 1 shown in FIGS. 2 and 3. In connection with the printing condition setting function, they are the same as the operations of the receiver 100 and printer 200 corresponding to Embodiment 3 shown in FIGS. 9 and 10. Therefore, explanation is omitted here.

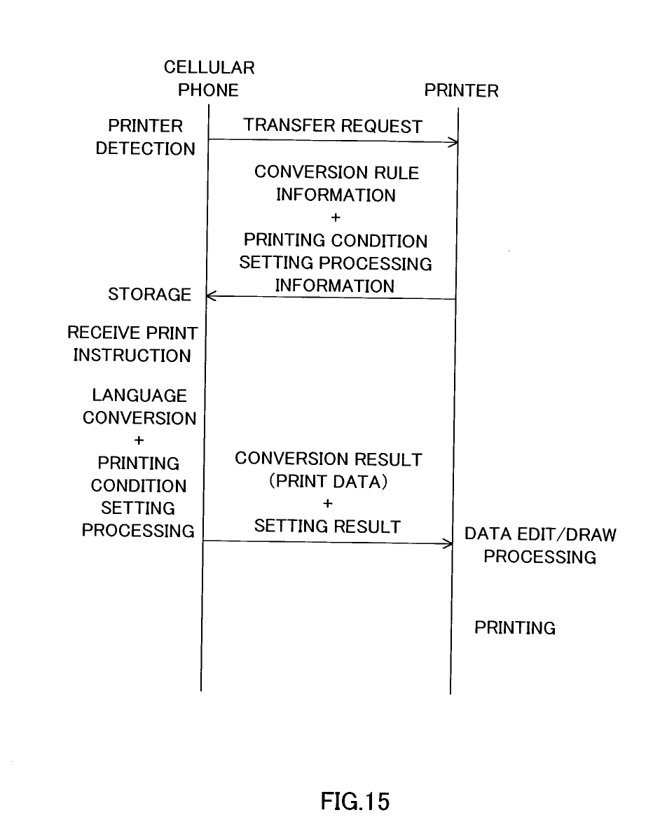

An explanation will be next given of procedures executed when the i-mode contents received by the cellular phone 400 are printed by the printer 200 (including procedures executed when the printing condition is set at the cellular phone 400) with an example of an operation sequence view shown in FIG. 15. Additionally, in the explanation given below, step numbers in FIGS. 2, 3, 9 and 10 are cited where necessary.

When the printer 200 is connected to the cellular phone 400 or the power of the printer 200 connected to the cellular phone 400 is turned on, the cellular phone 400 detects this state (S1000: YES) and sends the printer 200 a transfer request relating to conversion rule information, which is used to convert received CHTML data (i-mode contents) into XML data for printing (for example, XSLT style sheet for CHTML), and CHTML printing condition setting processing information, which is used to set the printing condition at the cellular phone 400 (S1100, S1150).

Then, when receiving the transfer request (S2000: YES, S2050: YES), the printer 200 extracts designated conversion rule information (XSLT style sheet for CHTML) from the conversion rule information storing section 202 on the one hand and transmits the extracted conversion rule information to the cellular phone 400 (S2100). The printer 200 extracts designated printing condition setting processing information for CHTML from the printing condition setting processing storing section 212 on the other hand, and transmits extracted printing condition setting processing information to the cellular phone 400 similarly (S2150).

After that, when receiving conversion rule information on the one hand (S1200: YES), the cellular phone 400 temporarily stores received conversion rule information to the conversion rule information storing section 104 (S1300). When receiving printing condition setting processing information on the other hand (S1250: YES), the cellular phone 400 temporarily stores received printing condition setting processing information in the printing condition setting processing information storing section 118 (S1350).

Then, when an instruction to print is input by a user (S1400: YES), the cellular phone 400 checks that accurate conversion rule information is stored in the conversion rule information storing section 104 on the one hand (S1500: YES). Thereafter, the cellular phone 400 converts CHTML data of received i-mode contents into print XML data, which is printable by the printer 200, using the XSLT processor and the conversion rule information (S1600), and transmits a conversion result (XML data for printing) to the printer 200 as print data (S1700). The cellular phone 400 checks that accurate printing condition setting processing information is stored in the printing condition setting processing information storing section 118 on the other hand (S1550: YES). Thereafter, script processing for setting the printing condition is carried out using the printing condition setting processing information, so that the user interfaces (screen of GUI and the action of input operation) are controlled to set the printing condition in accordance with the user's input operation (S1650), and to transmit the setting result (set printing condition) to the printer 200 (S1750).

After that, when receiving the conversion result (XML data for printing) and the setting result (set printing condition) (S2000: NO, S2200: YES, S2250: YES), the printer 200 provides data edit processing that reflects received setting printing condition and draw processing to received XML data for printing to generate print data subjected to bitmap decompression (S2300). Then, the printer 200 prints generated printing data subjected to bitmap decompression on printing paper (S2400).

In this way, according to the information printing system of this embodiment, the cellular phone 400 can set the printing condition, which depends on the printer 200, and the printer 200 can print the i-mode contents (data described in CHTML) received by the cellular phone 400 in an output form with a relatively simple structure without installing the printer driver onto the cellular phone 400.

Moreover, it is possible to set the printing condition, which is different for each model of printer 200, without changing software of the cellular phone 400, and it is also possible to reduce processing task loads for setting the printing condition at the cellular phone 400.

Additionally, in this embodiment, timing with which the cellular phone 400 receives printing condition setting processing information from the printer 200 is the point in time when the printer 200 is connected to the cellular phone 400, or time when the power of the printer 200 connected to the cellular phone 400 is turned on. However, the present invention is not limited to this. For example, timing may be the point in time when printing is actually carried out (when an instruction to print is input by the user) or time when the user of cellular phone 400 inputs the setting of printing condition to the cellular phone 400.

Furthermore, though this embodiment explains the case in which the i-mode contents received with the cellular phone 400 is printed with the printer 200, an object to be printed is not limited to the i-mode contents. Data provided for printing, which has been downloaded (download data for printing), may also be possible. Data for printing downloaded onto the cellular phone 400 is normally described in CHTML.

As explained above, according to the present invention, data (information), which is handled by an arbitrary client apparatus of digital system, can be printed in an output form, which is suitable for printing, with a relatively simple structure without using the printer driver.

The present invention is not limited to the above-described embodiments, and various variations and modifications may be possible without departing from the scope of the present invention.

This application is based on the Japanese Patent Application No. 2001-148380 filed on May 17, 2001 and the Japanese Patent Application No. 2001-216027 filed on Jul. 16, 2001, entire contents of which are expressly incorporated by reference herein.

What is claimed is:

1. An information printing system which comprises a client apparatus that processes document data in a first markup language format described in a first markup language and a printing apparatus that is connected to the client apparatus and that receives and prints document data in a second markup language format described in a second markup language different from the first markup language,
wherein the printing apparatus comprises:
means for storing conversion rule information that is used to convert document data in the first markup language format processable by the client apparatus into document data in the second markup language format printable by the printing apparatus; and
means for obtaining the conversion rule information from the storing means and transmitting the obtained conversion rule information to the client apparatus, and
wherein the client apparatus comprises:
means for receiving the conversion rule information transmitted from the printing apparatus;
means for converting the document data in the first markup language format into the document data in the second markup language format, based on the received conversion rule information; and
means for transmitting the document data in the second markup language format after conversion to the printing apparatus.

2. The information printing system according to claim 1, wherein in the printing apparatus, the storing means stores a plurality of conversion rule information corresponding to a plurality of kinds of document data in the first markup language format, and the transmitting means obtains conversion rule information corresponding to a kind of document data in the first markup language format processable by the client apparatus from the storing means and transmits the obtained conversion rule information to the client apparatus.

3. The information printing system according to claim 1, wherein in the printing apparatus, the storing means stores a plurality of conversion rule information that is used to convert document data in the first markup language format into document data in the second markup language format and that has different conversion contents, and the transmitting means includes a selecting section for selecting one conversion rule information from the storing means, and obtains the conversion rule information selected by the selecting section from the storing means and transmits the obtained conversion rule information to the client apparatus.

4. The information printing system according to claim 1, wherein the client apparatus is a television broadcast receiver.

5. The information printing system according to claim 1, wherein the client apparatus is a cellular phone.

6. The information printing system according to claim 1, wherein the client apparatus is an Internet terminal.

7. The information printing system according to claim 1, wherein the client apparatus further comprises means for detecting the fact that the printing apparatus has been connected, and when the fact is detected that the printing apparatus has been connected, obtains the conversion rule information from the storing means.

8. The information printing system according to claim 1, wherein the client apparatus further comprises means for detecting the fact that a power of the printing apparatus has been turned on, and when the fact is detected that the power of the printing apparatus has been turned on, obtains the conversion rule information from the storing means.

9. A data converting method in an information printing system which comprises a client apparatus that processes document data in a first markup language format described in a first markup language and a printing apparatus that is connected to the client apparatus and that receives and prints document data in a second markup language format described in a second markup language different from the first markup language, comprising the steps of:
the printing apparatus's transmitting conversion rule information, that is stored in the printing apparatus and that is used to convert document data in the first markup language format processable by the client apparatus into document data in the second markup language format printable by the printing apparatus, to the client apparatus;
the client apparatus's receiving the conversion rule information transmitted from the printing apparatus;
the client apparatus Is converting the document data in the first markup language format into the document data in the second markup language format, based on the received conversion rule information; and
the client apparatus's transmitting the document data in the second markup language format after conversion to the printing apparatus.

10. A printing apparatus that receives and prints document data in a second markup language format described in a second markup language, comprising:
means for storing conversion rule information that is used to convert document data in a first markup language format described in a first markup language different from the second markup language into document data in the second markup language format; and
means for obtaining the conversion rule information from the storing means and transmitting the obtained conversion rule information.

11. A data transferring method in a printing apparatus that receives and prints document data in a second markup language format described in a second markup language, wherein conversion rule information that is stored in the printing apparatus and that is used to convert document data in a first markup language format described in a first markup language different from the second markup language format into document data in the second markup language format is transmitted.

12. A client apparatus that processes document data in a first markup language format described in a first markup language, comprising:
means for receiving conversion rule information that is used to convert document data in the first markup language format into document data in a second markup language format described in a second markup language different from the first markup language;
means for converting the document data in the first markup language format into the document data in the second markup language format, based on the received conversion rule information; and
means for transmitting the document data in the second markup language format after conversion.

13. A data processing method in a client apparatus that processes document data in a first markup language format described in a first markup language, comprising the steps of:
receiving conversion rule information that is used to convert document data in the first markup language format into document data in a second markup language format described in a second markup language different from the first markup language;
converting the document data in the first markup language format into the document data in the second markup language format, based on the received conversion rule information; and
transmitting the document data in the second markup language format after conversion.

14. An information printing system which comprises a client apparatus and a printing apparatus connected to the client apparatus,
wherein the printing apparatus comprises:
means for storing printing condition setting processing information that is described in a markup language processable by the client apparatus and that includes a script for setting a printing condition to the printing apparatus by the client apparatus; and
means for obtaining the printing condition setting processing information from the storing means and transmitting the obtained printing condition setting processing information to the client apparatus, and
wherein the client apparatus comprises:
means for receiving the printing condition setting processing information transmitted from the printing apparatus;
means for controlling a user interface based on the received printing condition setting processing information to set a printing condition in accordance with an input from a user; and
means for transmitting the set printing condition to the printing apparatus.

15. The information printing system according to claim 14, wherein in the printing apparatus, the storing means stores a plurality of printing condition setting processing information corresponding to a plurality of kinds of client apparatuses, and the transmitting means obtains printing condition setting processing information corresponding to the client apparatus from the storing means and transmits the obtained printing condition setting processing information to the client apparatus.

16. A printing condition setting method for an information printing system which comprises a client apparatus and a printing apparatus connected to the client apparatus, comprising the steps of:
the printing apparatus's transmitting printing condition setting processing information, that is stored in the printing apparatus, that is described in a markup language processable by the client apparatus, and that includes a script for setting a printing condition to the printing apparatus by the client apparatus, to the client apparatus;
the client apparatus's receiving the printing condition setting processing information transmitted from the printing apparatus;
the client apparatus's controlling a user interface based on the received printing condition setting processing information to set a printing condition in accordance with an input from a user; and
the client apparatus's transmitting the set printing condition to the printing apparatus.

17. A printing apparatus capable of setting a printing condition, comprising:
means for storing printing condition setting processing information including a script for setting a printing condition to the printing apparatus that is described in a markup language; and
means for obtaining the printing condition setting processing information from the storing means and transmitting the obtained printing condition setting processing information.

18. A data transferring method for a printing apparatus capable of setting a printing condition, wherein printing condition setting processing information that is stored in the printing apparatus and that includes a script for setting a printing condition to the printing apparatus that is described in a markup language is transmitted

19. A client apparatus that processes data, comprising:
means for receiving printing condition setting processing information including a script for setting a printing condition to a printing apparatus that is described in a markup language;
means for controlling a user interface based on the received printing condition setting processing information to set a printing condition in accordance with an input from a user; and
means for transmitting the set printing condition.

20. A data processing method for a client apparatus that processes data, comprising the steps of:
receiving printing condition setting processing information including a script for setting a printing condition to a printing apparatus that is described in a markup language;
controlling a user interface based on the received printing condition setting processing information to set a printing condition in accordance with an input by a user; and
transmitting the set printing condition.

21. The information printing system according to claim 14, wherein in the client apparatus, the setting means includes means for generating a command interpretable/executable by the printing apparatus corresponding to the set printing condition, and the transmitting means transmits the generated command to the printing apparatus.

22. The information printing system according to claim 21, wherein the printing condition setting processing information includes a description relating to a printing condition that can be set by the printing apparatus and a command interpretable/executable by the printing apparatus corresponding to the printing condition, and the generating means selects a command corresponding to the set printing condition based on the description included in the printing condition setting processing information.

23. The information printing system according to claim 21, wherein the command, when the printing condition includes a plurality of setting items, is a data row having a plurality of commands corresponding to the respective setting items as its elements.

24. A computer readable medium containing instructions for controlling a computing device to execute a method according to claim 11.

25. A computer readable medium containing instructions for controlling a computing device to execute a method according to claim 13.

26. A computer readable medium containing instructions for controlling a computing device to execute a method according to claim 18.

27. A computer readable medium containing instructions for controlling a computing device to execute a method according to claim 20.
